(19) United States
(12) Patent Application Publication
(10) Pub. No.: US 2012/0256909 A1
(43) Pub. Date: Oct. 11, 2012

(54) IMAGE PROCESSING APPARATUS, IMAGE PROCESSING METHOD, AND PROGRAM

(76) Inventors: Toshinori IHARA, Tokyo (JP); Takuro KAWAI, Tokyo (JP); Goh KOBAYASHI, Tokyo (JP); Keisuke YAMAOKA, Tokyo (JP)

(21) Appl. No.: 13/428,845

(22) Filed: Mar. 23, 2012

(30) Foreign Application Priority Data
Apr. 8, 2011 (JP) 2011-086307

(51) Int. Cl. G06T 15/00

(52) U.S. Cl. 345/419

(57) ABSTRACT

A generating unit allocates an image of a predetermined viewpoint to two or more viewpoints in a 3D image display unit that displays images of the two or more viewpoints in a direction differing according to a viewpoint based on an input from a user. A driving processing unit causes the image of the predetermined viewpoint to be displayed on the 3D image display unit based on the allocation. For example, the present technology can be applied to an image processing apparatus for a 3D image.

### BACKGROUND

The present technology relates to an image processing apparatus, an image processing method, and a program, and more particularly, to an image processing apparatus, an image processing method, and a program, which are capable of changing a method of displaying an image, which is displayed by a display device that displays a multi-viewpoint image in a direction differing according to a viewpoint, according to a user.

A display device that allows a three-dimensional (3D) image to be viewed without using 3D viewing glasses (hereinafter referred to as a “naked eye type display device”) is a display device that displays a multi-viewpoint image in a direction differing according to a viewpoint. In the naked eye type display device, it is effective to enlarge a viewing position to increase the number of viewpoints of a 3D image to be displayed.

In the naked eye type display device, techniques of independently showing an N-viewpoint image to a viewer in M different directions have been proposed (for example, see Japanese Patent Application Laid-Open No. 2010-014891). Further, in the naked eye type display device, when the number of viewpoints of an input image is less than the number of viewpoints in the naked eye type display device (hereinafter referred to as “display viewpoints”), a viewpoint image generating process for generating a new viewpoint image needs to be performed on the input image. In regard to the viewpoint image generating process, a method of improving the quality of a generated image, a method of reducing a processing cost, and the like have been proposed (see Japanese Patent Application Laid Open Nos. 2005-151534, 2005-252459, and 2009-258726).

### SUMMARY

Meanwhile, in a conventional naked eye type display device, a viewpoint of an image corresponding to a display viewpoint is fixed. In other words, in the conventional naked eye type display device, a display method of a 3D image is decided in advance. Thus, it has been difficult to change a display method of a 3D image according to a user.

The present technology is made in light of the foregoing, and it is desirable to change a display method of an image displayed by a naked eye type display device according to a user.

According to an embodiment of the present technology, there is provided an image processing apparatus that includes an allocating unit that allocates an image of a predetermined viewpoint to two or more viewpoints in a display device that displays images of the two or more viewpoints in a direction differing according to a viewpoint, based on an input from a user, and a display control unit that causes the image of the predetermined viewpoint to be displayed on the display device based on an allocation by the allocating unit.

According to another embodiment of the present technology, there are provided an image processing method and a program, which correspond to the image processing apparatus according to the embodiment of the present technology.

According to an embodiment of the present technology, an image of a predetermined viewpoint is allocated to two or more viewpoints in a display device that displays images of the two or more viewpoints in a direction differing according to a viewpoint, based on an input from a user, and the image of the predetermined viewpoint is displayed on the display device based on the allocation.

According to the embodiments of the present technology, a display method of an image displayed by a naked eye type display device can be changed according to a user.

### BRIEF DESCRIPTION OF THE DRAWINGS

FIG. 1 is a block diagram illustrating a configuration example of an image processing apparatus according to a first embodiment of the present technology;

FIG. 2 is a block diagram illustrating a first detailed configuration example of an image signal processing unit illustrated in FIG. 1;

FIG. 3 is a block diagram illustrating a first detailed configuration example of an M-viewpoint image generating unit;

FIG. 4 is a block diagram illustrating a second detailed configuration example of the M-viewpoint image generating unit;

FIG. 5 is a block diagram illustrating a third detailed configuration example of the M-viewpoint image generating unit;

FIG. 6 is a block diagram illustrating a fourth detailed configuration example of the M-viewpoint image generating unit;

FIG. 7 is a diagram illustrating an example of an M-viewpoint image;

FIG. 8 is a diagram illustrating a configuration example of display viewpoint information;

FIG. 9 is a diagram illustrating a description example of display viewpoint information;

FIG. 10 is a diagram illustrating a description example of display viewpoint information;

FIG. 11 is a diagram illustrating a description example of display viewpoint information;

FIG. 12 is a diagram illustrating a description example of display viewpoint information;

FIG. 13 is a diagram for describing a relation between a display image displayed on the basis of the display viewpoint information of FIG. 9 and a viewing position;

FIG. 14 is a diagram for describing a relation between a display image displayed on the basis of the display viewpoint information of FIG. 11 and a viewing position;

FIG. 15 is a flowchart for describing image processing of the image processing apparatus of FIG. 1;

FIG. 16 is a flowchart for describing a display viewpoint information generating process of the image signal processing unit of FIG. 2;

FIG. 17 is a block diagram illustrating a second detailed configuration example of the image signal processing unit illustrated in FIG. 1;

FIG. 18 is a block diagram illustrating a third detailed configuration example of the image signal processing unit illustrated in FIG. 1;

FIG. 19 is a flowchart for describing a display viewpoint information generating process of the image signal processing unit of FIG. 18;

FIG. 20 is a block diagram illustrating a fourth detailed configuration example of the image signal processing unit illustrated in FIG. 1;

FIG. 21 is a block diagram illustrating a fifth detailed configuration example of the image signal processing unit illustrated in FIG. 1;

FIG. 22 is a flowchart for describing image processing of an image processing apparatus including the image signal processing unit of FIG. 21;

FIG. 23 is a flowchart for describing a display viewpoint information generating process of the image signal processing unit of FIG. 21;

FIG. 24 is a block diagram illustrating a sixth detailed configuration example of the image signal processing unit illustrated in FIG. 1;

FIG. 25 is a flowchart for describing a display viewpoint information generating process of the image signal processing unit of FIG. 24; and

FIG. 26 is a diagram illustrating a configuration example of an embodiment of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

[Configuration Example of Image Processing Apparatus According to First Embodiment]

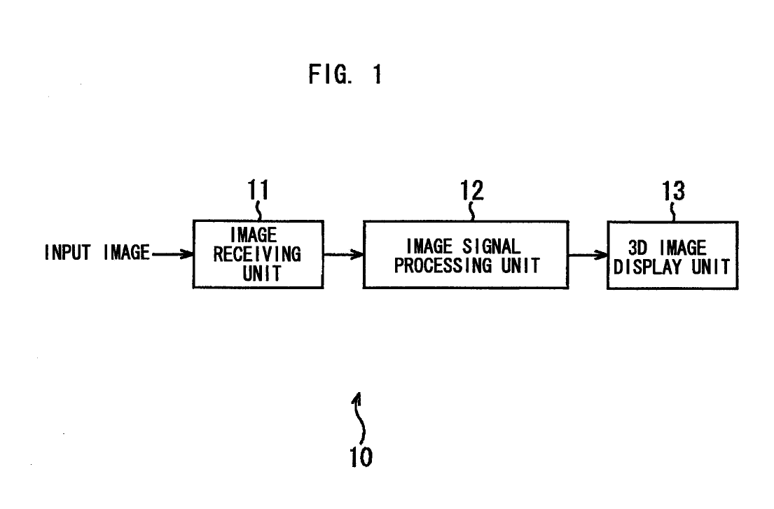

FIG. 1 is a block diagram illustrating a configuration example of an image processing apparatus according to a first embodiment of the present technology.

An image processing apparatus 10 of FIG. 1 includes an image receiving unit 11, an image signal processing unit 12, and a 3D image display unit 13, and displays an image.

The image receiving unit 11 of the image processing apparatus 10 receives an analog signal of an input image input from the outside. The image receiving unit 11 performs analog-to-digital (A/D) conversion on the received input image, and supplies the image signal processing unit 12 with a digital signal of the input image obtained as the A/D conversion result. In the following description, the digital signal of the input image is appropriately referred to simply as “input image.”

The image signal processing unit 12 performs predetermined image processing or the like on the input image supplied from the image receiving unit 11, and generates images of M viewpoints (M is a natural number of 2 or more) which are display viewpoints of the 3D image display unit 13 as a display image. The image signal processing unit 12 supplies the 3D image display unit 13 with the generated display image.

The 3D image display unit 13 is a naked eye type display device capable of displaying an M-viewpoint 3D image, which is represented by a parallax bather type and a lenticular type. The 3D image display unit 13 displays the display image supplied from the image signal processing unit 12.

[First Detailed Configuration Example of Image Signal Processing Unit]

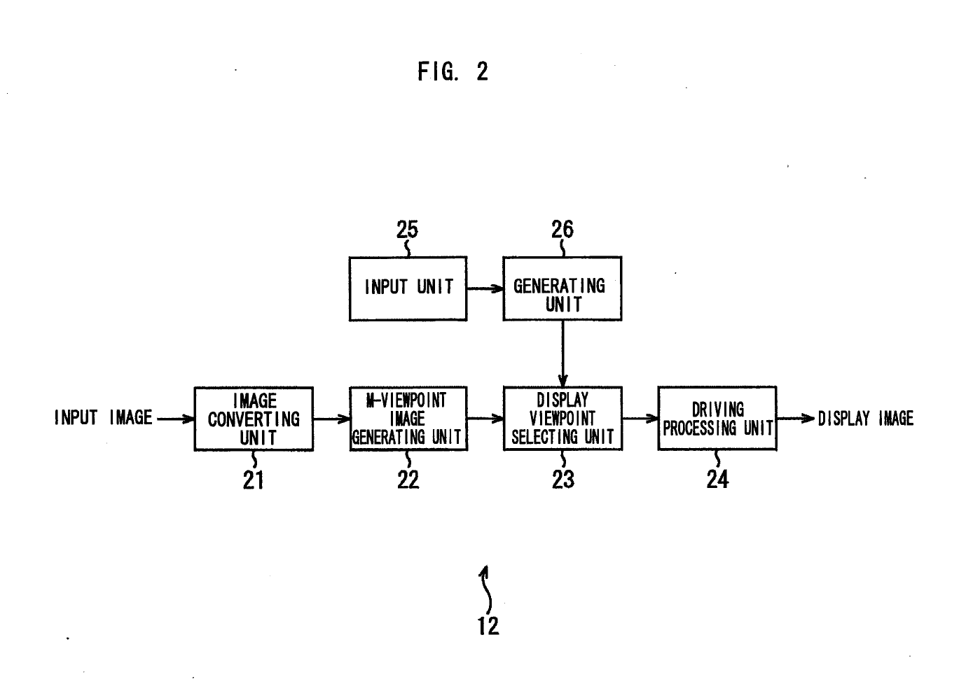

FIG. 2 is a block diagram illustrating a first detailed configuration example of the image signal processing unit 12 illustrated in FIG. 1.

The image signal processing unit 12 of FIG. 2 includes an image converting unit 21, an M-viewpoint image generating unit 22, a display viewpoint selecting unit 23, a driving processing unit 24, an input unit 25, and a generating unit 26.

The image converting unit 21 of the image signal processing unit 12 performs predetermined image processing such as a decompression process, a resolution converting process of converting to the resolution corresponding to the 3D image display unit 13, a color conversion process, and a noise reduction process, on the input image supplied from the image receiving unit 11 illustrated in FIG. 1. The image converting unit 21 supplies the M-viewpoint image generating unit 22 with the input image which has been subjected to the image processing.

When the number of viewpoints of the input image supplied from the image converting unit 21 is smaller than M, the M-viewpoint image generating unit 22 generates an M-viewpoint image by performing an interpolation process on the input image. The M-viewpoint image generating unit 22 supplies the display viewpoint selecting unit 23 with the generated M-viewpoint image or the input M-viewpoint image as an M-viewpoint image.

The display viewpoint selecting unit 23 generates a display image based on display viewpoint information supplied from the generating unit 26 such that an image of a predetermined viewpoint, which corresponds to each display viewpoint and is included in the M-viewpoint image supplied from the M-viewpoint image generating unit 22, is used as an image of each display viewpoint. The display viewpoint selecting unit 23 supplies the driving processing unit 24 with the generated display image. The display viewpoint information refers to information representing an image of a predetermined viewpoint, which is included in the M-viewpoint image, allocated to each display viewpoint of the 3D image display unit 13.

The driving processing unit 24 performs, for example, a process of converting a format of the display image supplied from the display viewpoint selecting unit 23 to a format corresponding to an interface of the 3D image display unit 13. The driving processing unit 24 functions as a display control unit, supplies the 3D image display unit 13 with the resultant display image and causes the display image to be displayed through the 3D image display unit 13.

The input unit 25 is configured with a controller and the like. The input unit 25 receives an operation input by the user and supplies the generating unit 26 with information corresponding to the operation.

The generating unit 26 functions as an allocating unit. In other words, the generating unit 26 generates display viewpoint information based on information supplied from the input unit 25 and allocates an image of a predetermined viewpoint included in the M-viewpoint image to each display viewpoint of the 3D image display unit 13. The generating unit 26 holds the generated display viewpoint information. The generating unit 26 supplies the display viewpoint selecting unit 23 with the held display viewpoint information.

[Detail Configuration Example of M-Viewpoint Image Generating Unit]

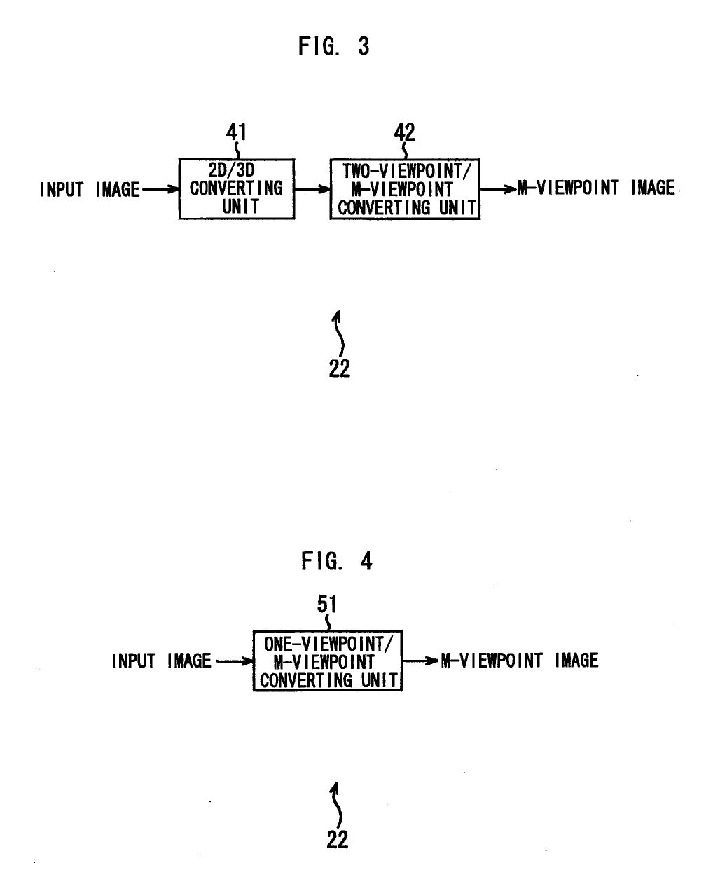

FIG. 3 is a block diagram illustrating a first detailed configuration example of the M-viewpoint image generating unit 22 when an input image is a one-viewpoint image.

The M-viewpoint image generating unit 22 of FIG. 3 includes a 2D/3D converting unit 41 and a two-viewpoint/M-viewpoint converting unit 42.

The 2D/3D converting unit 41 of the M-viewpoint image generating unit 22 performs an interpolation process for generating a new one-viewpoint image on the input image supplied from the image converting unit 21 of FIG. 2 by shifting the input image by a predetermined distance in a horizontal direction. The 2D/3D converting unit 41 supplies the two-viewpoint/M-viewpoint converting unit 42 with the generated one-viewpoint image and the input image as a two-viewpoint image.

The two-viewpoint/M-viewpoint converting unit 42 performs an interpolation process for generating an (M-2)-viewpoint image on any one image included in the two-viewpoint image supplied from the 2D/3D converting unit 41 by shifting any one image included in the two-viewpoint image by a distance corresponding to each viewpoint in the horizontal direction for each of viewpoints of the (M-2)-viewpoint image to be generated. The two-viewpoint/M-viewpoint converting unit 42 supplies the display viewpoint selecting unit 23 illustrated in FIG. 2 with the generated (M-2)-viewpoint image and the two-viewpoint image.

FIG. 4 is a block diagram illustrating a second detailed configuration example of the M-viewpoint image generating unit 22 when an input image is a one-viewpoint image.

The M-viewpoint image generating unit 22 of FIG. 4 is configured with a one-viewpoint/M-viewpoint converting unit 51.

The one-viewpoint/M-viewpoint converting unit 51 of the M-viewpoint image generating unit 22 performs an interpolation process for generating an (M-1) viewpoint image on the input image supplied from the image converting unit 21 illustrated in FIG. 2 by shifting the input image by a distance corresponding to each viewpoint in the horizontal direction for each viewpoint of the (M-1)-viewpoint image to be generated. The one-viewpoint/M-viewpoint converting unit 51 supplies the display viewpoint selecting unit 23 illustrated in FIG. 2 with the generated (M-1)-viewpoint image and the input image as the M-view point image.

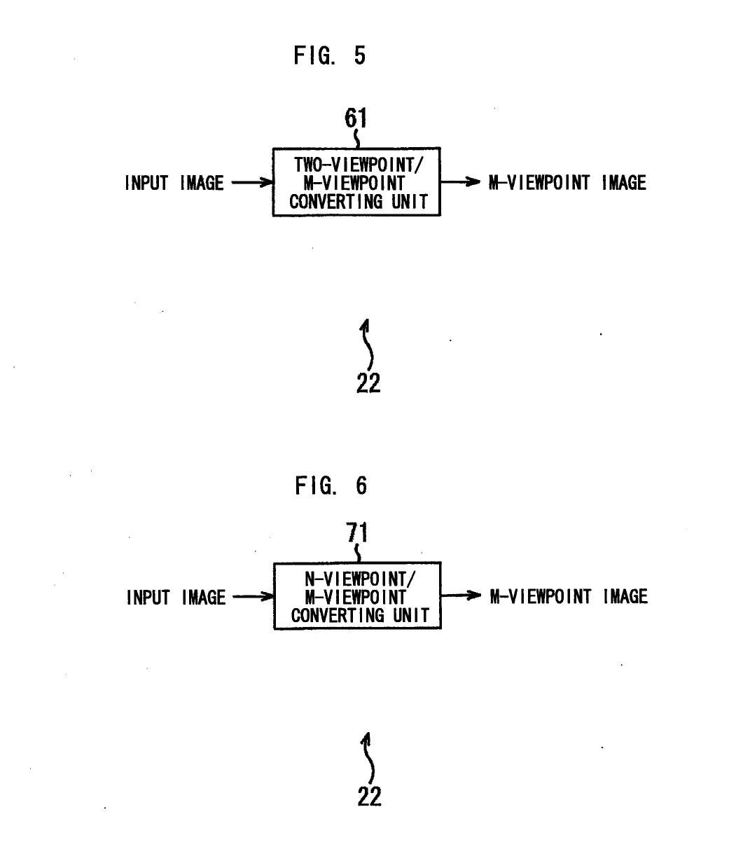

FIG. 5 is a block diagram illustrating a detailed configuration example of the M-viewpoint image generating unit 22 when an input image is a two-viewpoint image.

The M-viewpoint image generating unit 22 of FIG. 5 is configured with a two-viewpoint/M-viewpoint converting unit 61.

The two-viewpoint/M-viewpoint converting unit 61 of the M-viewpoint image generating unit 22 performs an interpolation process for generating an (M-2)-viewpoint image on any one image included in the two-viewpoint image which is the input image supplied from the image converting unit 21 illustrated in FIG. 2. Specifically, the two-viewpoint/M-viewpoint converting unit 61 shifts any one image included in the two-viewpoint image which is the input image by a distance corresponding to each viewpoint in the horizontal direction for each viewpoint of the (M-2)-viewpoint image to be generated. The two-viewpoint/M-viewpoint converting unit 61 supplies the display viewpoint selecting unit 23 illustrated in FIG. 2 with the generated (M-2)-viewpoint image and the input image as the M-viewpoint image.

FIG. 6 is a block diagram illustrating a detailed configuration example of the M-viewpoint image generating unit 22 when an input image is an N-viewpoint image (N is a natural number smaller than M).

The M-viewpoint image generating unit 22 of FIG. 6 is configured with an N-viewpoint/M-viewpoint converting unit 71.

The N-viewpoint/M-viewpoint converting unit 71 of the M-viewpoint image generating unit 22 performs an interpolation process for generating an (M-N)-viewpoint image on any one image included in an N-viewpoint image which is the input image supplied from the image converting unit 21 illustrated in FIG. 2. Specifically, the N-viewpoint/M-viewpoint converting unit 71 shills any one image included in the N-viewpoint image which is the input image by a distance corresponding to each viewpoint in the horizontal direction for each viewpoint of the (M-N)-viewpoint image to be generated. The N-viewpoint/M-viewpoint converting unit 71 supplies the display viewpoint selecting unit 23 illustrated in FIG. 2 with the generated (M-N)-viewpoint image and the input image as the M-viewpoint image.

[Example of M-Viewpoint Image]

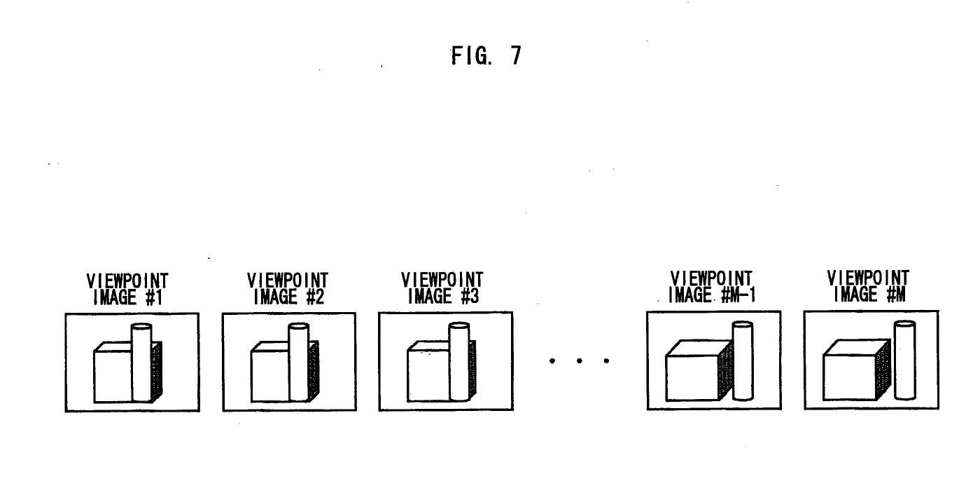

FIG. 7 is a diagram illustrating an example of an M-viewpoint image generated by the M-viewpoint image generating unit 22.

In FIG. 7, an i-th viewpoint image is designated as a viewpoint image #i.

As illustrated in FIG. 7, the M-viewpoint image includes M images having different viewpoints, i.e., viewpoint images #1 to #M.

[Configuration Example of Display Viewpoint Information]

FIG. 8 is a diagram illustrating a configuration example of display viewpoint information.

As illustrated in FIG. 8, the display viewpoint information is information configured such that each display viewpoint of the 3D image display unit 13 is associated with image designation information designating an image to be allocated to each display viewpoint. In FIG. 8, an i-th display viewpoint is designated as a display viewpoint #i.

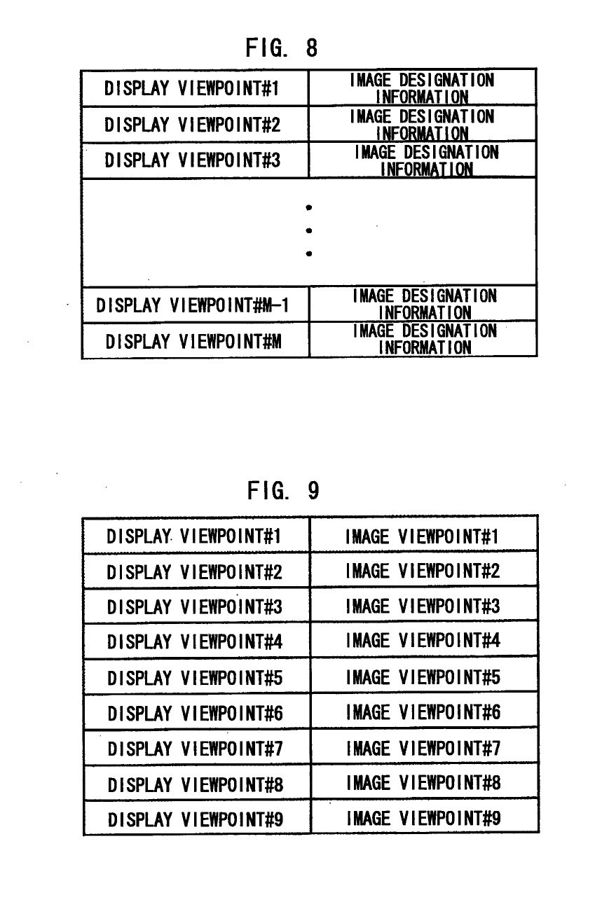

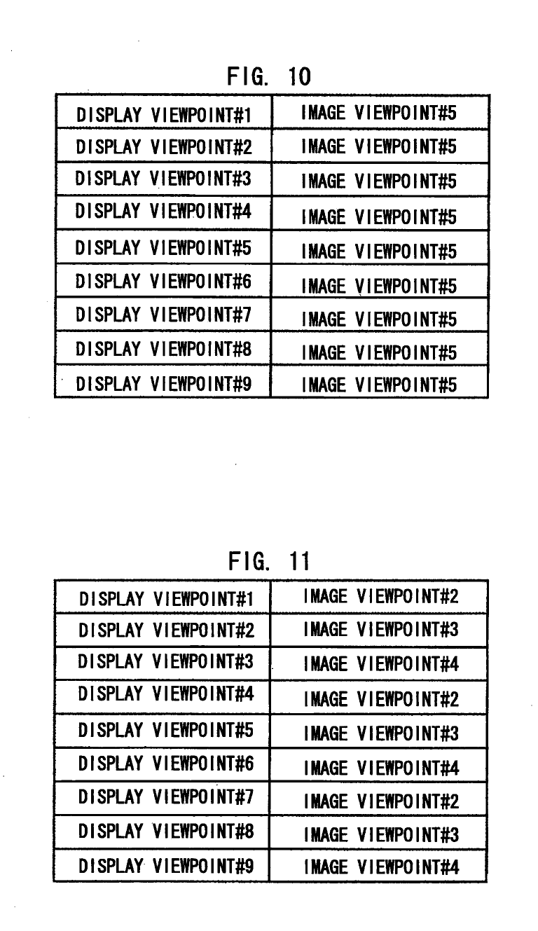

FIGS. 9 to 12 are diagrams illustrating description examples of the display viewpoint information.

In FIGS. 9 to 12, the number M of display viewpoints is 9. Further, an image viewpoint #i refers to an ID allocated to an i-th viewpoint among 9 viewpoints of a 9-viewpoint image. An ID allocated to a viewpoint is set such that IDs of adjacent viewpoints are consecutive. In other words, viewpoints of image viewpoints #1 to #9 are arranged in order.

In the display viewpoint information of FIG. 9, display viewpoints #1 to #9 are associated with the image viewpoints #1 to #9 as image viewpoint information, respectively. Thus, when a display image is generated based on the display viewpoint information of FIG. 9, viewpoint images of the 9-viewpoint image are displayed as display viewpoint images, respectively. This allows the user to view a 3D image without using 3D viewing glasses through 2 viewpoint images viewable from a viewing position among 9 viewpoint images. Further, even when the viewing position changes as the user moves, a viewpoint of a 3D image is smoothly switched, and thus kinematic parallax can be obtained.

In the display viewpoint information of FIG. 10, all display viewpoints #1 to #9 are associated with the image viewpoint #5 as image viewpoint information. Thus, when a display image is generated based on the display viewpoint information of FIG. 10, a viewpoint image of the image viewpoint #5 included in the 9-viewpoint image is displayed as an image for all display viewpoints. This allows the user to view a 2D image without parallax.

In the display viewpoint information of FIG. 11, display viewpoints #1 to #3, display viewpoints #4 to #6, and display viewpoints #7 to #9, which are three consecutive display viewpoints, respectively, are associated with the image viewpoints #2 to #4 as image viewpoint information, respectively. Thus, when a display image is generated based on the display viewpoint information of FIG. 11, viewpoint images of the image viewpoints #2 to #4 included in the 9-viewpoint image are displayed as images of the display viewpoints #1 to #3, images of the display viewpoints #4 to #6, and images of the display viewpoints #7 to #9, respectively.

Thus, a 3D image of the same directivity can be viewed at three viewing positions which correspond to the display viewpoints #1 to #3, the display viewpoints #4 to #6, and the display viewpoints #7 to #9, respectively. For example, the same 3D image can be viewed at a viewing position at which images of the display viewpoints #1 and #2 can be viewed, at a viewing position at which images of the display viewpoints #4 and #5 can be viewed, and at a viewing position at which images of the display viewpoints #7 and #8 can be viewed.

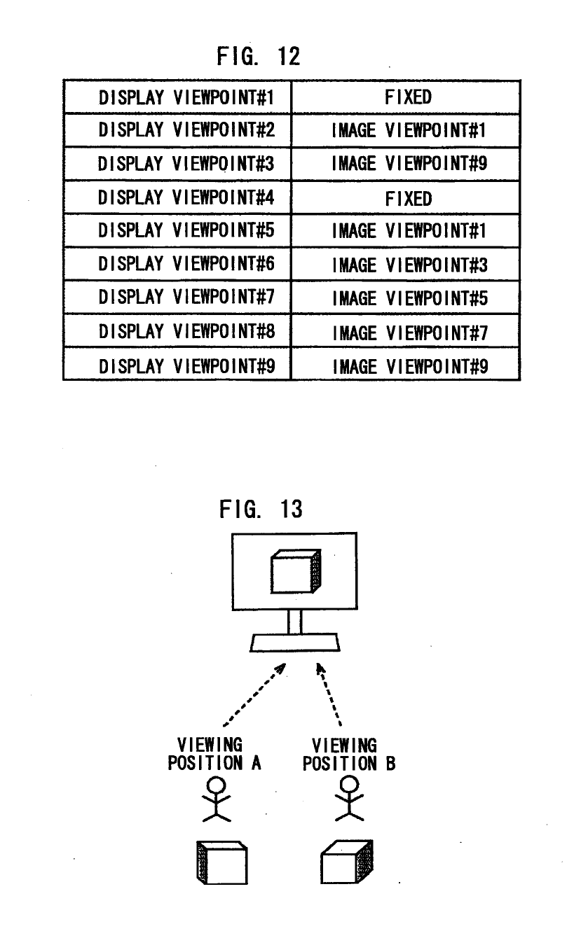

In the display viewpoint information of FIG. 12, the display viewpoints #1 and #4 are associated with “fixed” designating a predetermined image (for example, a black image) previously decided as the image designation information. Further, display viewpoints corresponding to a distance between the user's left and right eyes, for example, the display viewpoints #2 and #3 which are two consecutive display viewpoints, are associated with the image viewpoints #1 and #9 which are viewpoints having a relatively large distance therebetween as the image viewpoint information, respectively. Further, two consecutive display viewpoints among the display viewpoints #5 to #9 are associated with IDs of viewpoints having a relatively small distance therebetween, for example, IDs of every other viewpoints as the image viewpoint information. Specifically, the display viewpoints #5 to #9 are associated with the image viewpoint #1, the image viewpoint #3, the image viewpoint #5, the image viewpoint #7, and the image viewpoint #9, respectively, as the image viewpoint information.

This allows the user to view a 3D image having a sense of depth that differs according to the viewing position. For example, the user can view a 3D image having a stronger sense of depth at a viewing position at which images of the display viewpoints #2 and #3 can be viewed than a viewing position at which images of adjacent viewing points among the display viewpoints #5 to #9 can be viewed.

Further, even when the M-viewpoint image generating unit 22 generates an M-viewpoint image by interpolation and M is relatively large, the user can view a 3D image having a strong sense of depth. Specifically, when the M-viewpoint image generating unit 22 generates an M-viewpoint image by interpolation, the M-viewpoint image can be easily generated compared to when the M-viewpoint image is generated by extrapolation. However, as M increases, a distance between viewpoints decreases. For example, when viewpoints of the M-viewpoint image are allocated to display viewpoints in order, as in the display viewpoint information of FIG. 8, a distance between viewpoints of images, which are allocated to two display viewpoints corresponding to a distance between the user's left and right eyes, decreases, and thus a sense of depth of a 3D image viewed by the user decreases. However, in the display viewpoint information of FIG. 12, viewpoints of the M-viewpoint image allocated to adjacent display viewpoints are not adjacent to each other. Thus, even when M is large, a sense of depth of a 3D image viewed by the user can be increased.

An image obtained by alpha-blending a plurality of viewpoint images (for example, a plurality of viewpoint images displayed nearby) included in the M-viewpoint image as well as any one image included in the M-viewpoint image or a predetermined image which is decided in advance may be used as an image allocated to a display viewpoint.

[Description of Relation between Display Image and Viewing Position]

FIG. 13 is a diagram for describing a relation between a display image displayed on the basis of the display viewpoint information of FIG. 9 and a viewing position.

As illustrated in FIG. 13, when a display image is displayed on the basis of the display viewpoint information of FIG. 9, a user viewing at a predetermined viewing position A and a user viewing at a predetermined viewing position B different from the viewing position A view 3D images configured of different two-viewpoint images, respectively. In other words, directivity of a display image viewed at the viewing position A is different from directivity of a display image viewed at the viewing position B.

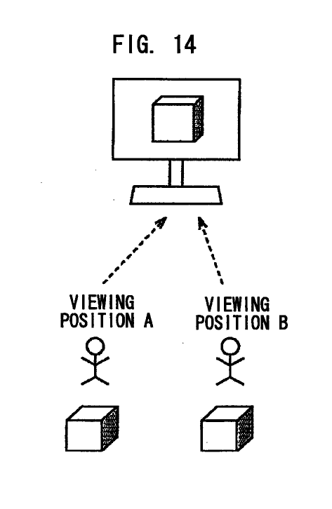

FIG. 14 is a diagram for describing a relation between a display image displayed on the basis of the display viewpoint information of FIG. 11 and a viewing position.

As illustrated in FIG. 14, when a display image is displayed on the basis of the display viewpoint information of FIG. 11, a user viewing at a predetermined viewing position A and a user viewing at a predetermined viewing position B different from the viewing position A view 3D images having the same directivity. In the example of FIG. 14, the viewing position A and the viewing position B are positions corresponding to any one of the display viewpoints #1 to #3, the display viewpoints #4 to #6, and the display viewpoints #7 to #9.

[Description of Processing of Image Processing Apparatus]

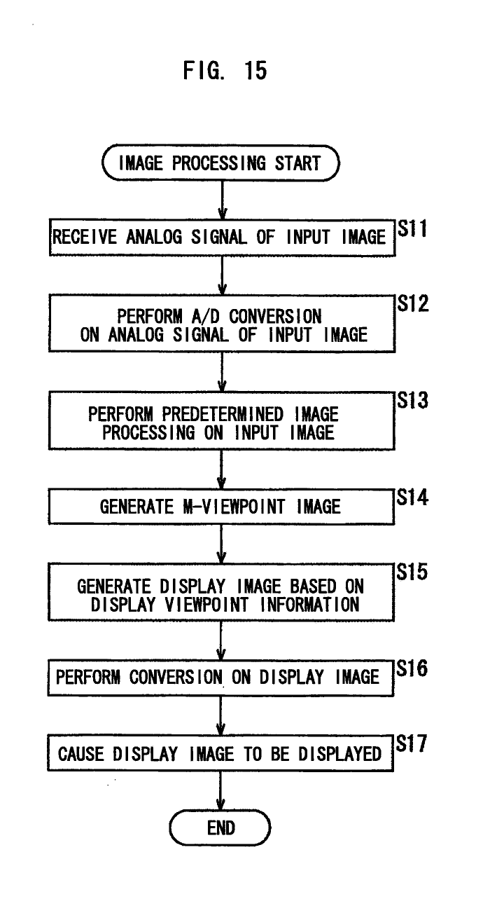

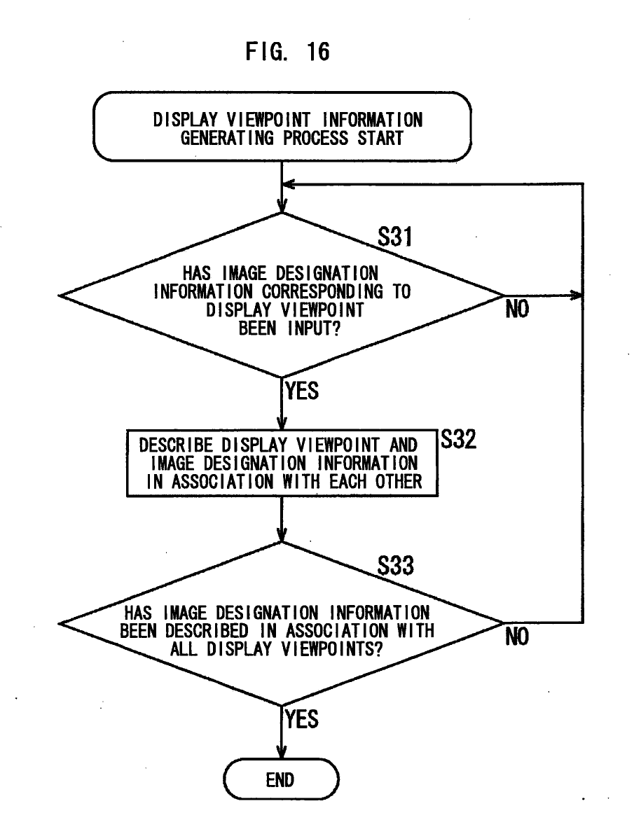

FIG. 15 is a flowchart for describing image processing of the image processing apparatus 10 of FIG. 1. For example, this image processing starts when an analog signal of an input image is input to the image processing apparatus 10.

Referring to FIG. 15, in step S11, the image receiving unit 11 of the image processing apparatus 10 receives an analog signal of an input image input from the outside.

In step S12, the image receiving unit 11 performs A/D conversion on the analog signal of the received input image, and supplies the image signal processing unit 12 with a digital signal of the input image obtained as the A/D conversion result.

In step S13, the image converting unit 21 of the image signal processing unit 12 performs predetermined image processing, such as a decompression process, a resolution converting process of converting to the resolution corresponding to the 3D image display unit 13, a color conversion process, and a noise reduction process, on the input image supplied from the image receiving unit 11. The image converting unit 21 supplies the M-viewpoint image generating unit 22 with the input image which has been subjected to the image processing.

In step S14, the M-viewpoint image generating unit 22 generates an M-viewpoint image by performing an interpolation process or the like on the input image supplied from the image converting unit 21, and then supplies the display viewpoint selecting unit 23 with the generated M-viewpoint image.

In step S15, the display viewpoint selecting unit 23 generates a display image based on display viewpoint information supplied from the generating unit 26 such that an image of a predetermined viewpoint, which corresponds to each display viewpoint and is included in the M-viewpoint image supplied from the M-viewpoint image generating unit 22, is used as an image of each display viewpoint. Then, the display viewpoint selecting unit 23 supplies the driving processing unit 24 with the display image.

In step S16, the driving processing unit 24 performs, for example, a process of converting a format of the display image supplied from the display viewpoint selecting unit 23 to a format corresponding to an interface of the 3D image display unit 13.

In step S17, the driving processing unit 24 supplies the display image obtained as the processing result of step S16 to the 3D image display unit 13 and causes the display image to be displayed through the 3D image display unit 13. Then, the process ends.

FIG. 16 is a flowchart for describing a display viewpoint information generating process of the image signal processing unit 12 of FIG. 2. For example, the display viewpoint information generating process starts when the user operates the input unit 25 and instructs generation of the display viewpoint information.

Referring to FIG. 16, in step S31, the input unit 25 determines whether or not image designation information corresponding to any one of M viewpoints which are display viewpoints of the 3D image display unit 13 has been input from the user. Specifically, the input unit 25 determines whether or not an operation for inputting image designation information corresponding to any one of M viewpoints has been received by the user.

When it is determined in step S31 that no image designation information corresponding to any of the M viewpoints which are display viewpoints has been input from the user yet, the input unit 25 is on standby until the image designation information is input.

However, when it is determined in step S31 that the image designation information corresponding to any one of M viewpoints which are display viewpoints has been input from the user, the input unit 25 supplies the generating unit 26 with the display viewpoint and the image designation information.

Then, in step S32, the generating unit 26 describes the display viewpoint and the image designation information supplied from the input unit 25 in association with each other.

In step S33, the generating unit 26 determines whether or not the image designation information has been described in association with all display viewpoints of the 3D image display unit 13. When it is determined in step S33 that the image designation information has not been described in association with all display viewpoints of the 3D image display unit 13 yet, the process returns to step S31, and step S31 and subsequent processes are repeated.

However, when it is determined in step S33 that the image designation information has been described in association with all display viewpoints of the 3D image display unit 13, the generating unit 26 holds all display viewpoints and the image viewpoint information described in association with the display viewpoints as display viewpoint information. Then, the generating unit 26 supplies the display viewpoint selecting unit 23 with the display viewpoint information, and then ends the process.

As described above, the image processing apparatus 10 generates the display viewpoint information based on the user's input, and causes the display image to be displayed based on the display viewpoint information. Thus, the display method of the display image can be changed according to the user.

As a result, for example, the user can view a 3D image having directivity that differs according to the viewing position by performing an operation for generating the display viewpoint information of FIG. 9 or can view a 2D image by performing an operation for generating the display viewpoint information of FIG. 10. Further, the user can view a 3D image having the same directivity at different view positions by performing an operation for generating the display viewpoint information of FIG. 11. Furthermore, the user can view a 3D image having a sense of depth that differs according to the viewing position by performing an operation for generating the display viewpoint information of FIG. 12. In other words, the user can select a viewing mode or can adjust a change in directivity, a sense of depth, or the like of a 3D image according to the viewing position.

[Second Detailed Configuration Example of Image Signal Processing Unit]

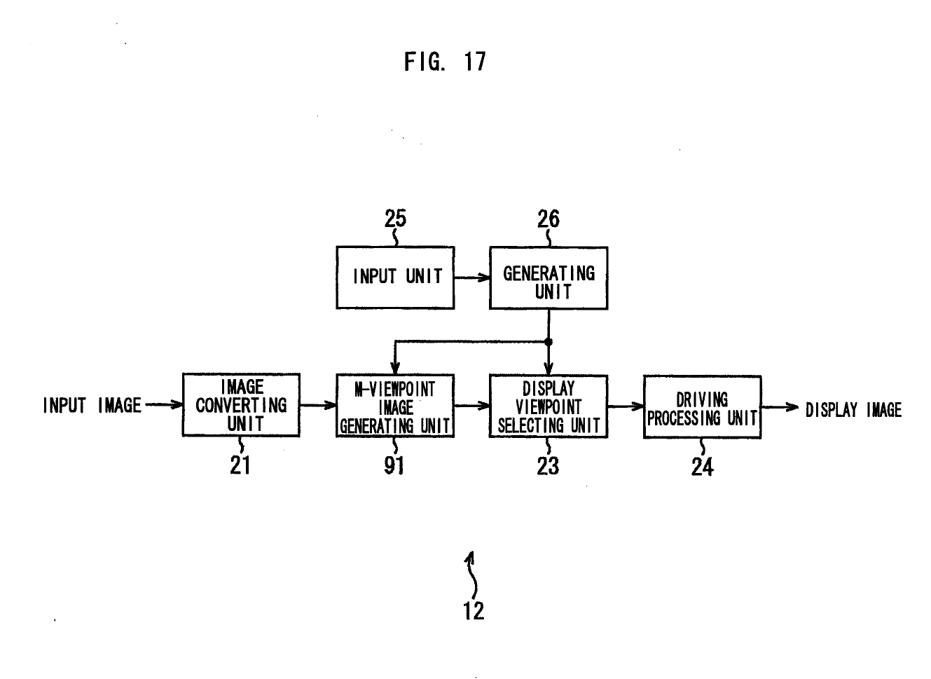

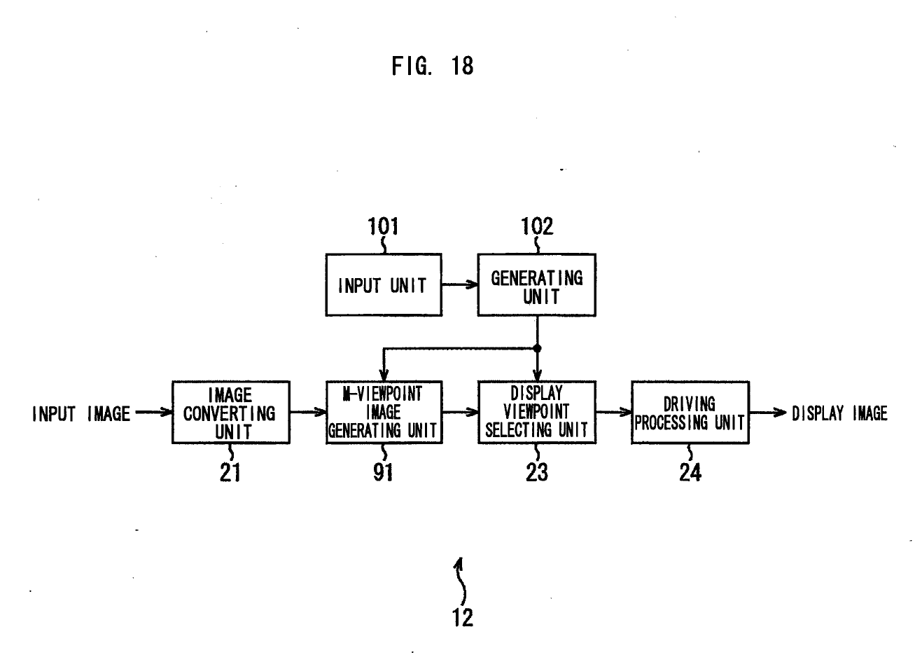

FIG. 17 is a block diagram illustrating a second detailed configuration example of the image signal processing unit 12 illustrated in FIG. 1.

Among components illustrated in FIG. 17, the same components as the components illustrated in FIG. 2 are denoted by the same reference numerals, and thus the redundant description thereof will be appropriately omitted.

The configuration of the image signal processing unit 12 of FIG. 17 is different from a configuration illustrated in FIG. 2 mainly in that an M-viewpoint image generating unit 91 is provided instead of the M-viewpoint image generating unit 22. The image signal processing unit 12 of FIG. 17 generates only an image of a viewpoint designated by the image designation information of the display viewpoint information instead of the M-viewpoint image.

Specifically, the M-viewpoint image generating unit 91 of the image signal processing unit 12 of FIG. 17 performs an interpolation process on the input image supplied from the image converting unit 21 based on the display viewpoint information generated by the generating unit 26 and generates an image of a viewpoint designated by the image designation information of the display viewpoint information. Then, the M-viewpoint image generating unit 91 supplies the display viewpoint selecting unit 23 with the generated image. Here, when the input image is an image of a viewpoint designated by the image designation information of the display viewpoint information, the M-viewpoint image generating unit 91 supplies the display viewpoint selecting unit 23 with the input image as is.

As described above, the image signal processing unit 12 of FIG. 17 generates only an image of a viewpoint, which is used as a display image, designated by the image designation information of the display viewpoint information. Thus, the image signal processing unit 12 of FIG. 17 can reduce a processing cost compared to the image signal processing unit 12 of FIG. 2.

[Third Configuration Example of Image Signal Processing Unit]

FIG. 18 is a block diagram illustrating a third detailed configuration example of the image signal processing unit 12 illustrated in FIG. 1.

Among components illustrated in FIG. 18, the same components as the components illustrated in FIG. 17 are denoted by the same reference numerals, and thus the redundant description thereof will be appropriately omitted.

A configuration of the image signal processing unit 12 of FIG. 18 is different from the configuration of FIG. 17 mainly in that an input unit 101 and a generating unit 102 are provided instead of the input unit 25 and the generating unit 26, respectively. The image signal processing unit 12 of FIG. 18 displays a display image based on viewing position information representing the user's viewing position and preference information representing a preference related to viewing such as a preference for a viewing mode or a preference of change in directivity or a sense of depth of a 3D image according to the viewing position.

Specifically, the input unit 101 of the image signal processing unit 12 of FIG. 18 is configured with a controller and the like, similarly to the input unit 25. The input unit 101 receives an input such as an operation for inputting viewing position information and an operation for inputting preference information from the user. Then, the input unit 101 supplies the generating unit 102 with the viewing position information and the preference information corresponding to the operations. The viewing position information may include not only information representing the viewing position and information representing a display viewpoint corresponding to an image viewable at the viewing position.

The generating unit 102 generates display viewpoint information based on the viewing position information and the preference information supplied from the input unit 101, and holds the generated display viewpoint information. Specifically, when the preference information represents a normal 3D image viewing mode as the preference for the viewing mode, the generating unit 102 generates and holds the display viewpoint information illustrated in FIG. 9. Further, for example, when the preference information represents a 2D image viewing mode as the preference for the viewing mode and display viewpoints corresponding to the viewing position information are the display viewpoints #4 and #5, the generating unit 102 generates and holds the display viewpoint information illustrated in FIG. 10.

Further, for example, when the preference information represents no change in directivity of a 3D image according to the viewing position as the preference and display viewpoints corresponding to the viewing position information are the display viewpoints #4 and #5, the generating unit 102 generates and holds the display viewpoint information illustrated in FIG. 11. Furthermore, for example, when the preference information represents change in a sense of depth of a 3D image according to the viewing position as the preference and display viewpoints corresponding to the viewing position information are the display viewpoints #2 and #3, the generating unit 102 generates and holds the display viewpoint information illustrated in FIG. 12.

Furthermore, for example, when the preference information represents a viewing mode in which a 3D image is viewable only at a current viewing position as the preference for the viewing mode, the generating unit 102 generates and holds the following display viewpoint information. In other words, the generating unit 102 generates and holds display viewpoint information in which image designation information of a predetermined two-viewpoint image is associated with a display viewpoint corresponding to the viewing position information, and image designation information representing “fixed” is associated with display viewpoints other than the corresponding display viewpoint. Thus, the M-viewpoint image generating unit 91 need only generate a two-viewpoint image, and thus the processing cost of the M-viewpoint image generating unit 91 can be reduced.

The generating unit 102 supplies the held display viewpoint information to the M-viewpoint image generating unit 91 and the display viewpoint selecting unit 23.

The input unit 101 may be configured to receive operations by a plurality of users. In this case, when it is difficult to generate display viewpoint information corresponding to all users' viewing position information and preference information or when a display based on display viewpoint information corresponding to a certain user's viewing position information and preference information inflicts damage to other users, for example, the display viewpoint information of FIG. 9 or the display viewpoint information of FIG. 10 is generated.

[Description of Another Display Viewpoint Information Generating Process]

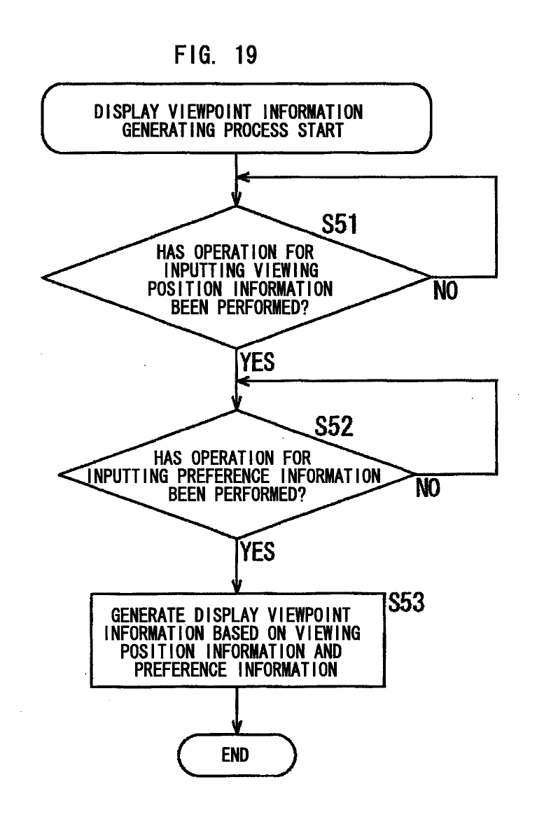

FIG. 19 is a flowchart for describing a display viewpoint information generating process of the image signal processing unit 12 of FIG. 18. For example, the display viewpoint information generating process starts when the user operates the input unit 101 and instructs generation of the display viewpoint information.

Referring to FIG. 19, in step S51, the input unit 101 of the image signal processing unit 12 determines whether an operation for inputting viewing position information has been performed by the user. When it is determined in step S51 that an operation for inputting viewing position information has not been performed by the user, the input unit 101 is on standby until an operation for inputting viewing position information is performed.

However, when it is determined in step S51 that an operation for inputting viewing position information has been performed by the user, the input unit 101 receives the operation, and supplies the viewing position information to the generating unit 102. In step S52, the input unit 101 determines whether an operation for inputting preference information has been performed by the user. When it is determined in step S52 that an operation for inputting preference information has not been performed, the input unit 101 is on standby until an operation for inputting preference information is performed.

However, when it is determined in step S52 that an operation for inputting preference information has been performed, the input unit 101 receives the operation and supplies the preference information to the generating unit 102.

Then, in step S53, the generating unit 102 generates display viewpoint information based on the viewing position information and the preference information supplied from the input unit 101, and holds the generated display viewpoint information. The generating unit 102 supplies the held display viewpoint information to the M-viewpoint image generating unit 91 and the display viewpoint selecting unit 23, and then ends the process.

[Fourth Configuration Example of Image Signal Processing Unit]

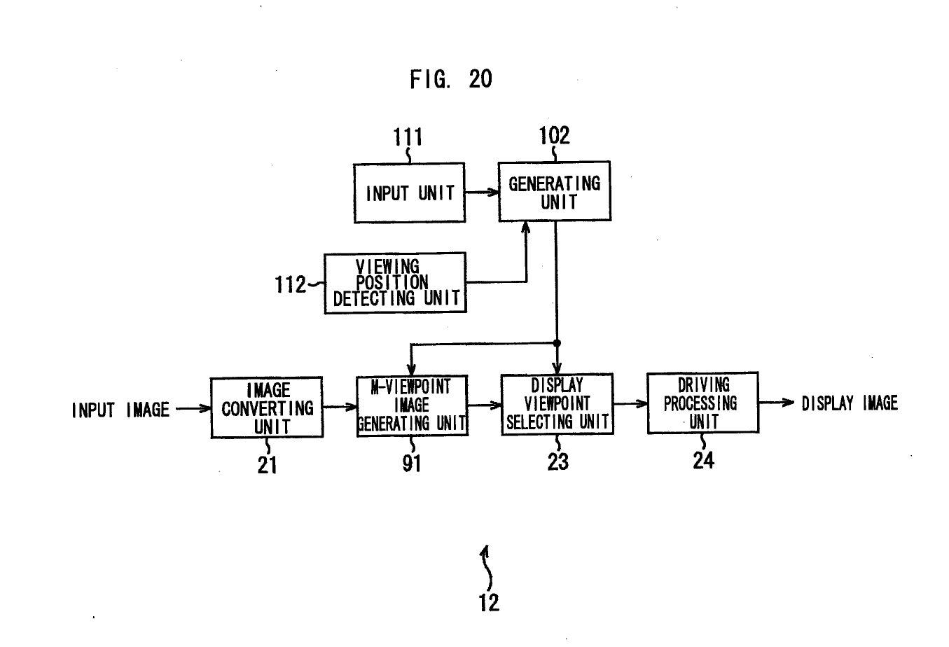

FIG. 20 is a block diagram illustrating a fourth detailed configuration example of the image signal processing unit 12 illustrated in FIG. 1.

Among components illustrated in FIG. 20, the same components as the components illustrated in FIG. 18 are denoted by the same reference numerals, and thus the redundant description thereof will be appropriately omitted.

A configuration of the image signal processing unit 12 of FIG. 20 is different from the configuration of FIG. 18 mainly in that an input unit 111 is provided instead of the input unit 101 and a viewing position detecting unit 112 is newly provided. The image signal processing unit 12 of FIG. 20 detects viewing position information.

Specifically, the input unit 111 of the image signal processing unit 12 is configured with a controller and the like, similarly to the input unit 25. The input unit 111 receives an input such as an operation for inputting preference information from the user. Then, the input unit 111 supplies the generating unit 102 with the preference information corresponding to the operations.

For example, the viewing position detecting unit 112 is configured with a stereo camera, an infrared ray sensor, or the like. The viewing position detecting unit 112 detects the user's viewing position, and supplies viewing position information representing the detected viewing position to the generating unit 102.

Further, in the image signal processing unit 12 of FIG. 20, the input unit 111 may receive an operation for inputting viewing position information by the user, and the generating unit 102 may use either of the viewing position information and the viewing position information from the viewing position detecting unit 112 for generation of display viewpoint information.

[Fifth Configuration Example of Image Signal Processing Unit]

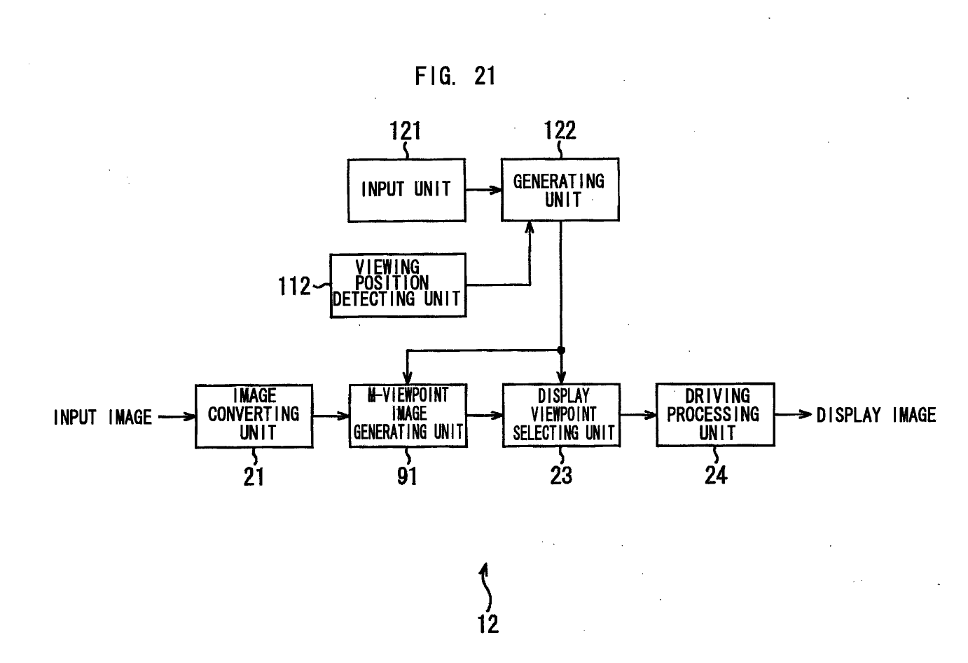

FIG. 21 is a block diagram illustrating a fifth detailed configuration example of the image signal processing unit 12 illustrated in FIG. 1.

Among components illustrated in FIG. 21, the same components as the components illustrated in FIG. 20 are denoted by the same reference numerals, and thus the redundant description thereof will be appropriately omitted.

A configuration of the image signal processing unit 12 of FIG. 21 is different from the configuration of FIG. 20 mainly in that an input unit 121 and a generating unit 122 are provided instead of the input unit 111 and the generating unit 102, respectively. The image signal processing unit 12 of FIG. 21 allocates only an input image to a display viewpoint in response to the user's operation for displaying a 3D graphics image such as a 3D menu image.

Specifically, the input unit 121 of the image signal processing unit 12 is configured with a controller and the like, similarly to the input unit 25. The input unit 121 receives an operation for inputting preference information, an operation for displaying a 3D graphics image, and the like from the user.

The input unit 121 supplies the generating unit 122 with the preference information corresponding to the operation for inputting preference information, similarly to the input unit 111. Further, the input unit 121 instructs the generating unit 122 to allocate only an input image to a display viewpoint in response to the operation for displaying a 3D graphics image.

The generating unit 122 generates display viewpoint information based on the preference information supplied from the input unit 121 and the viewing position information supplied from the viewing position detecting unit 112, and holds the generated display viewpoint information. Further, the generating unit 122 generates display viewpoint information in which image designation information of an input image is associated with each display viewpoint in response to an instruction to allocate only an input image supplied from the input unit 121 to a display viewpoint, and holds the generated display viewpoint information. The generating unit 122 supplies the held display viewpoint information to the display viewpoint selecting unit 23 and the M-viewpoint image generating unit 91. Thus, when the user performs an operation for displaying a 3D graphics image, the M-viewpoint image generating unit 91 supplies the display viewpoint selecting unit 23 with the input image as is.

[Description of Another Image Processing]

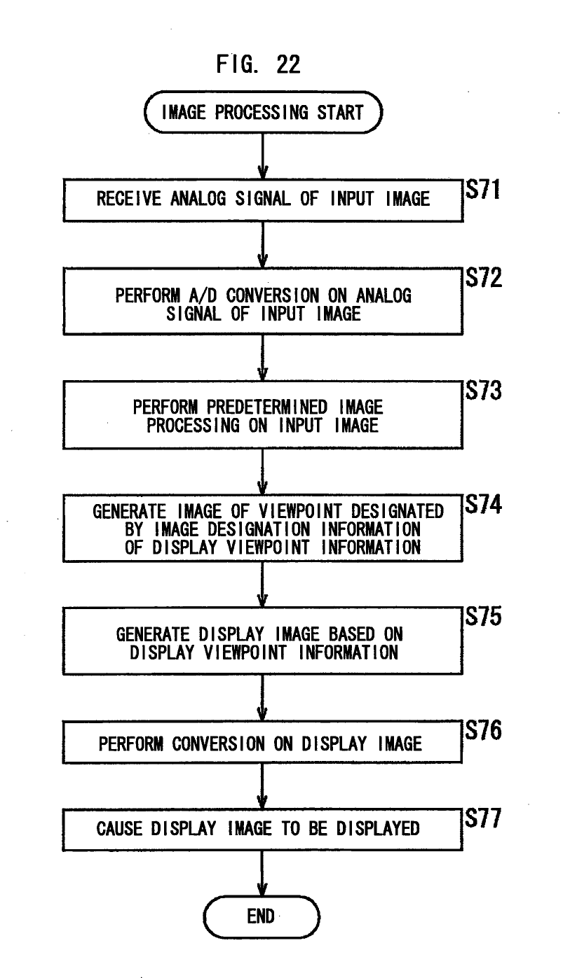

FIG. 22 is a flowchart for describing image processing of the image processing apparatus 10 including the image signal processing unit 12 of FIG. 21. For example, this image processing starts when an analog signal of an input image is input to the image processing apparatus 10.

Processes of steps S71 to S73 of FIG. 22 are the same as the processes of steps S11 to S13 of FIG. 15, and thus the redundant description will not be repeated.

In step S74, the M-viewpoint image generating unit 91 of FIG. 21 performs an interpolation process or the like on an input image supplied from the image converting unit 21 based on display viewpoint information generated by the generating unit 122, and generates an image of a viewpoint designated by the image designation information of the display viewpoint information. Then, the M-viewpoint image generating unit 91 supplies the generated image to the display viewpoint selecting unit 23.

When the user performs an operation for displaying a 3D graphics image, since the image of the viewpoint designated by the image designation information of the display viewpoint information is the input image, in processing of step S74, the input image is supplied to the display viewpoint selecting unit 23 as is.

Processes of steps S75 to S77 are the same as the processes of steps S15 to S17, and thus the redundant description will not be repeated.

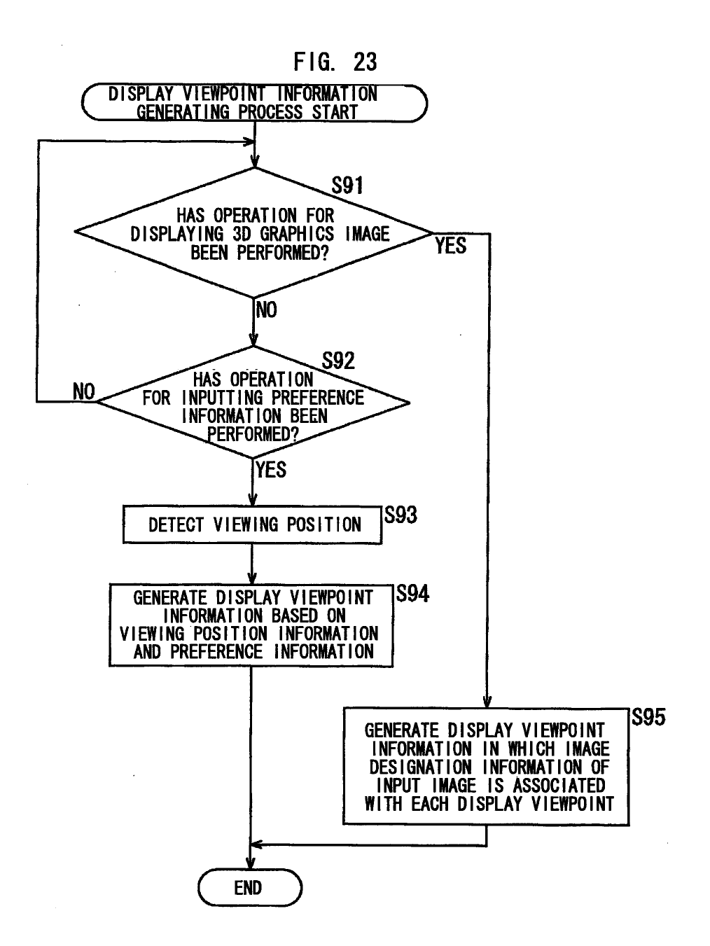

FIG. 23 is a flowchart for describing a display viewpoint information generating process of the image signal processing unit 12 of FIG. 21.

Referring to FIG. 23, in step S91, the input unit 121 determines whether or not the user has performed an operation for displaying a 3D graphics image. When it is determined in step S91 that the user has not performed an operation for displaying a 3D graphics image, the process proceeds to step S92.

In step S92, the input unit 121 determines whether or not the user has performed an operation for inputting preference information. When it is determined in step S92 that the user has not performed an operation for inputting reference information, the process returns to step S91.

However, when it is determined in step S92 that the user has performed an operation for inputting reference information, the input unit 121 receives the operation, and supplies the preference information to the generating unit 122. Then, in step S93, the viewing position detecting unit 112 detects the user's viewing position, and supplies viewing position information representing the viewing position to the generating unit 122.

In step S94, the generating unit 122 generates display viewpoint information based on the preference information supplied from the input unit 121 and the viewing position information supplied from the viewing position detecting unit 112, and holds the generated display viewpoint information. The generating unit 122 supplies the held display viewpoint information to the M-viewpoint image generating unit 91 and the display viewpoint selecting unit 23, and then ends the process.

Meanwhile, when it is determined in step S91 that the user has performed an operation for displaying a 3D graphics image, the process proceeds to step S95. In step S95, the generating unit 122 generates display viewpoint information in which the image designation information of the input image is associated with each display viewpoint, and holds the generated display viewpoint information. The generating unit 122 supplies the held display viewpoint information to the M-viewpoint image generating unit 91 and the display viewpoint selecting unit 23, and then ends the process.

As described above, when the user has performed an operation for displaying a 3D graphics image, that is, when the input image is a 3D graphics image, the image signal processing unit 12 of FIG. 21 allocates only the input image to the display viewpoint, thereby improving the image quality of the display image.

Specifically, a 3D graphics image has a geometric pattern and is precipitous in change of brightness or color. Thus, when the number of viewpoints of a 3D graphics image increases by the interpolation process or the like, the 3D graphics image which has been subjected to the interpolation process undergoes image degradation caused by an occlusion area (which will be described in detail later) or the like occurring at the time of the interpolation process, which is likely to be perceived by users. Thus, when the input image is a 3D graphics image, the image signal processing unit 12 of FIG. 21 does not allocate the input image which has been subjected to the interpolation process to the display viewpoint but allocates only the input image to the display viewpoint, thereby improving the image quality of the display image. Here, the occlusion area refers to an area which is present in an image of a certain viewpoint but not present in an image of another viewpoint due to a difference of viewpoint.

Furthermore, the image signal processing unit 12 of FIG. 21 allocates only the input image to the display viewpoint when the user has performed the operation for displaying a 3D graphics image. However, the image signal processing unit 12 of FIG. 21 may allocate only the input image to the display viewpoint when an error value of an image generated by the M-viewpoint image generating unit 91 is larger than a predetermined value.

[Sixth Configuration Example of Image Signal Processing Unit]

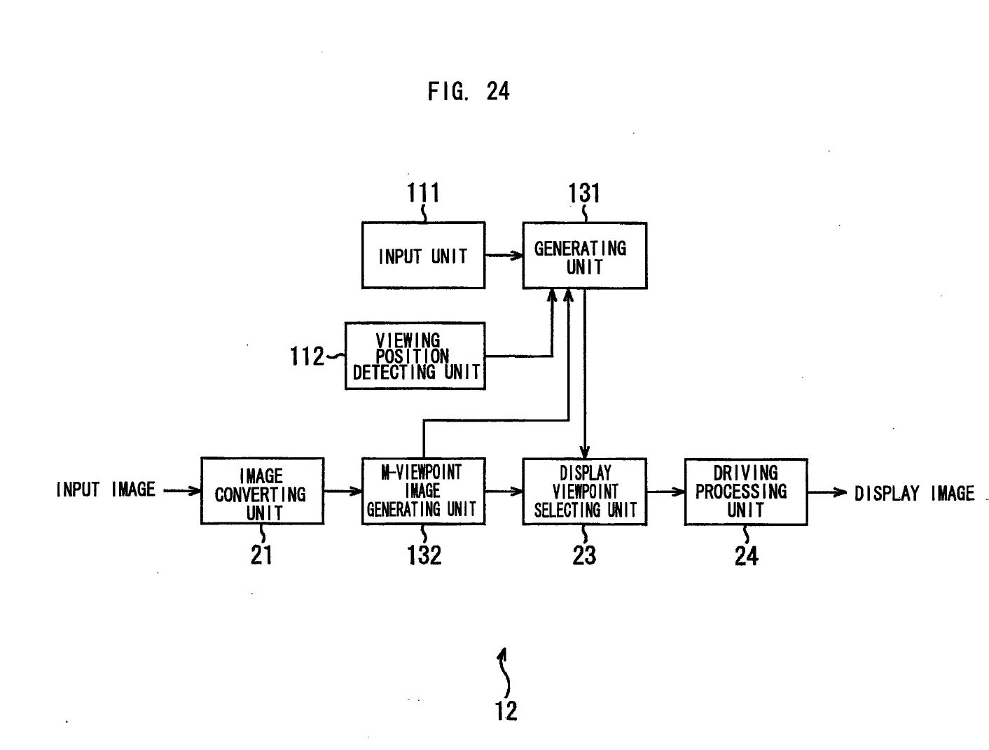

FIG. 24 is a block diagram illustrating a sixth detailed configuration example of the image signal processing unit 12 illustrated in FIG. 1.

Among components illustrated in FIG. 24, the same components as the components illustrated in FIG. 20 are denoted by the same reference numerals, and thus the redundant description thereof will be appropriately omitted.

A configuration of the image signal processing unit 12 of FIG. 24 is different from the configuration of FIG. 20 mainly in that a generating unit 131 and an M-viewpoint image generating unit 132 are provided instead of the generating unit 102 and the M-viewpoint image generating unit 91, respectively. The image signal processing unit 12 of FIG. 24 generates display viewpoint information based on a disparity image of an M-viewpoint image as well as the viewing position information and the preference information. The disparity image is also called a disparity map and is an image including a disparity value representing a distance in a horizontal direction between a screen position of each pixel of an image of a corresponding viewpoint and a screen position of a pixel of an image of a viewpoint, which is a base point, corresponding to the pixel.

The generating unit 131 of the image signal processing unit 12 of FIG. 24 generates display viewpoint information based on the preference information supplied from the input unit 111, the viewing position information supplied from the viewing position detecting unit 112, and the disparity image of the M-viewpoint image supplied from the M-viewpoint image generating unit 132, and holds the generated display viewpoint information.

Specifically, for example, the generating unit 131 first generates display viewpoint information based on the preference information and the viewing position information. Then, based on a disparity image of an image allocated to two display viewpoints corresponding to the viewing position, the generating unit 131 determines whether or not a difference between a minimum value and a maximum value of the position of a 3D image configured from the image in the depth direction is smaller than a predetermined value. When it is determined that the difference is smaller than the predetermined value, the generating unit 131 changes the image allocated to two display viewpoints corresponding to the viewing position so that the difference can be equal to or more than the predetermined value, based on the disparity image of the M-viewpoint image. The generating unit 131 supplies the held display viewpoint information to the display viewpoint selecting unit 23.

The M-viewpoint image generating unit 132 performs the interpolation process or the like on the input image supplied from the image converting unit 21, and generates the M-viewpoint image and the disparity image of the M-viewpoint image. The M-viewpoint image generating unit 132 supplies the M-viewpoint image to the display viewpoint selecting unit 23, and supplies the disparity image of the M-viewpoint image to the generating unit 131.

[Description of Another Display Viewpoint Information Generating Process]

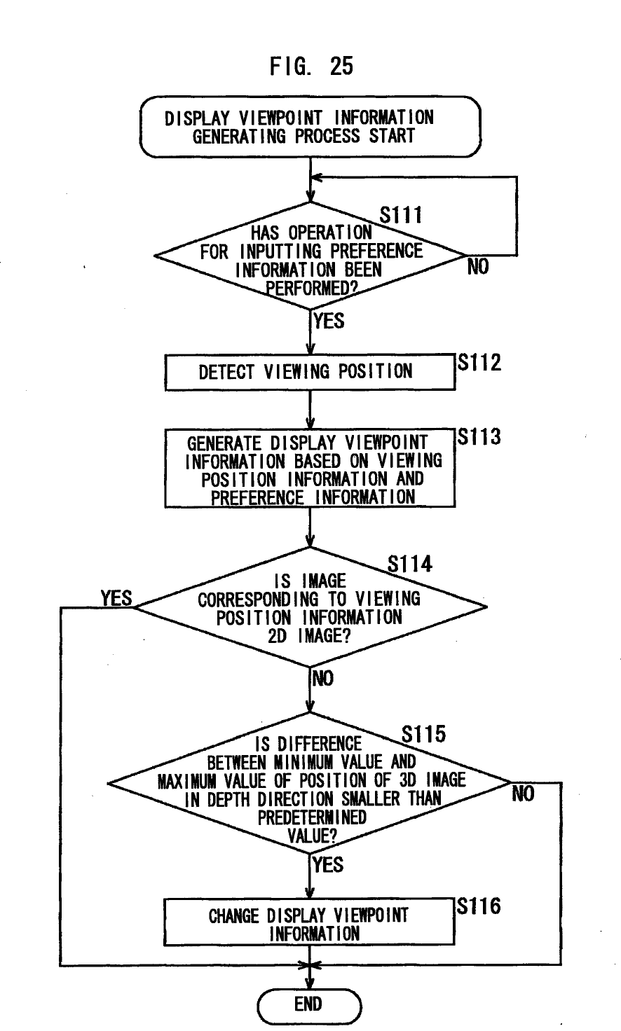

FIG. 25 is a flowchart for describing a display viewpoint information generating process of the image signal processing unit 12 of FIG. 24. For example, the display viewpoint information generating process starts when the user operates the input unit 111 and instructs generation of display viewpoint information.

Referring to FIG. 25, in step S111, the input unit 111 determines whether or not the user has performed an operation for inputting preference information. When it is determined in step S111 that the user has not performed an operation for inputting preference information, the input unit 111 is on standby until the operation is performed.

However, when it is determined in step S111 that the user has performed an operation for inputting preference information, the input unit 111 receives the operation, and supplies the preference information to the generating unit 131. Then, in step S112, the viewing position detecting unit 112 detects the user's viewing position, and supplies viewing position information representing viewing position to the generating unit 131.

In step S113, the generating unit 131 generates display viewpoint information based on the viewing position information supplied from the viewing position detecting unit 112 and the preference information supplied from the input unit 121, and holds the generated display viewpoint information. The generating unit 131 supplies the held display viewpoint information to the display viewpoint selecting unit 23. Thus, the M-viewpoint image generating unit 132 generates the M-viewpoint image from the input image, and supplies the M-viewpoint image to the display viewpoint selecting unit 23. Further, the M-viewpoint image generating unit 132 generates the disparity image of the M-viewpoint image, and supplies the disparity image to the generating unit 131.

In step S114, the generating unit 131 determines whether or not an image allocated to two display viewpoints corresponding to the viewing position information is a 2D image, that is, whether or not the image designation information corresponding to the viewing position information is the same, based on the display viewpoint information. When it is determined in step S114 that an image allocated to two display viewpoints corresponding the viewing position information is a 2D image, the process ends.

However, when it is determined in step S114 that an image allocated to two display viewpoints corresponding the viewing position information is not a 2D image, the process proceeds to step S115.

In step S115, the generating unit 131 determines whether or not a difference between a minimum value and a maximum value of the position of a 3D image, which is configured from the image allocated to the two display viewpoints corresponding to the viewing position information in the depth direction is smaller than a predetermined value based on the disparity image of the M-viewpoint image and the viewing position information supplied from the M-viewpoint image generating unit 132.

When it is determined in step S115 that the difference between the minimum value and the maximum value of the position of the 3D image in the depth direction is smaller than a predetermined value, in step S116, the generating unit 131 changes the display viewpoint information so that the difference can be equal to or more than the predetermined value, based on the disparity image of the M-viewpoint image. Specifically, the generating unit 131 changes the image allocated to the two display viewpoints corresponding to the viewing position information based on the disparity image of the M-viewpoint image so that the difference between the minimum value and the maximum value of the position of the 3D image in the depth direction can be equal to or more than the predetermined value. Then, the generating unit 131 generates display viewpoint information in which image designation information of the changed image is associated with two display viewpoints corresponding to the viewing position information, and holds the generated display viewpoint information. The generating unit 131 supplies the held display viewpoint information to the display viewpoint selecting unit 23, and then ends the process.

However, when it is determined in step S115 that the difference between the minimum value and the maximum value of the position of the 3D image in the depth direction is not smaller than a predetermined value, the process ends.

The image signal processing units 12 of FIGS. 18, 20, and 21 include the M-viewpoint image generating unit 91, however, they may include the M-viewpoint image generating unit 22.

In the above description, an analog signal of an input image is input from the outside to the image receiving unit 11, however, a digital signal of an input image may be input.

[Description of Computer to which Present Technology is Applied]

Next, a series of processes described above may be performed by hardware or software. When a series of processes is performed by software, a program configuring the software is installed in a general-purpose computer or the like.

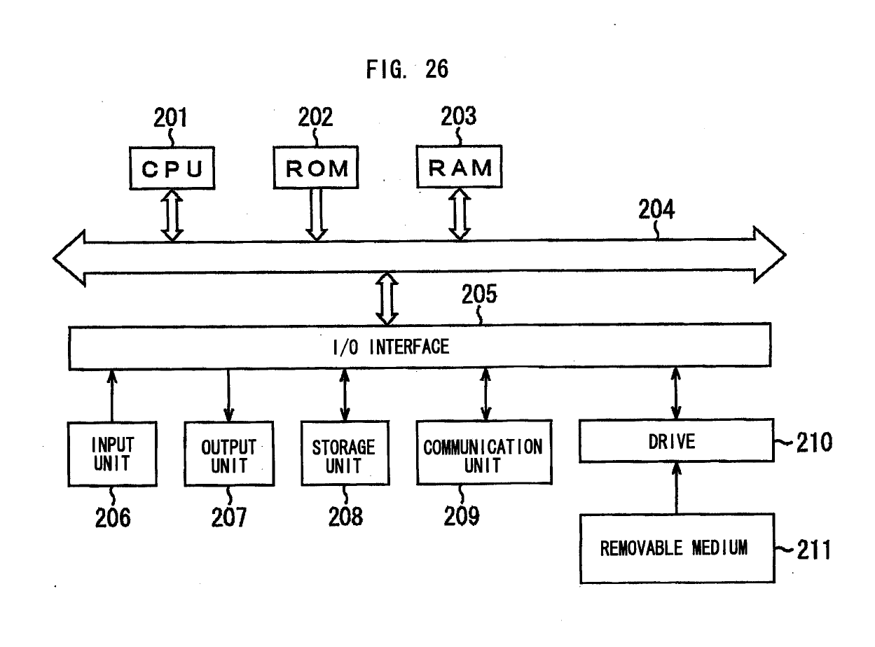

FIG. 26 illustrates a configuration example of an embodiment of a computer in which a program for executing a series of processes described above is installed.

The program may be recorded in a storage unit 208 or a read only memory (ROM) 202 functioning as a recording medium built in the computer in advance.

Alternatively, the program may be stored (recorded) in a removable medium 211. The removable medium 211 may be provided as so-called package software. Examples of the removable medium 211 include a flexible disk, a compact disc read only memory (CD-ROM), a magneto optical (MO) disc, a digital versatile disc (DVD), a magnetic disk, and a semiconductor memory.

Further, the program may be installed in the computer from the removable medium 211 through a drive 210. Furthermore, the program may be downloaded to the computer via a communication network or a broadcast network and then installed in the built-in storage unit 208. In other words, for example, the program may be transmitted from a download site to the computer through a satellite for digital satellite broadcasting in a wireless manner or may be transmitted to the computer via a network such as a local area network (LAN) or the Internet in a wired manner.

The computer includes a central processing unit (CPU) 201 therein, and an I/O interface 205 is connected to the CPU 201 via a bus 204.

When the user operates an input unit 206 and an instruction is input via the I/O interface 205, the CPU 201 executes the program stored in the ROM 202 in response to the instruction. Alternatively, the CPU 201 may load the program stored in the storage unit 208 to a random access memory (RAM) 203 and then execute the loaded program.

In this way, the CPU 201 performs the processes according to the above-described flowcharts or the processes performed by the configurations of the above-described block diagrams. Then, the CPU 201 outputs the processing result from an output unit 207 or transmits the processing result from a communication unit 209, for example, through the I/O interface 205, as necessary. Further, for example, the CPU 201 records the processing result in the storage unit 208.

The input unit 206 is configured with a keyboard, a mouse, a microphone, and the like. The output unit 207 is configured with a liquid crystal display (LCD), a speaker, and the like.

In the present disclosure, a process which a computer performs according to a program need not necessarily be performed in time series in the order described in the flowcharts. In other words, a process which a computer performs according to a program also includes a process which is executed in parallel or individually (for example, a parallel process or a process by an object).

Further, a program may be processed by a single computer (processor) or may be distributedly processed by a plurality of computers. Furthermore, a program may be transmitted to a computer at a remote site and then executed.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing apparatus, including:

an allocating unit that allocates an image of a predetermined viewpoint to two or more viewpoints in a display device that displays images of the two or more viewpoints in a direction differing according to a viewpoint based on an input from a user; and

a display control unit that causes the image of the predetermined viewpoint to be displayed on the display device based on an allocation by the allocating unit.

(2)

The image processing apparatus according to (1), wherein the allocating unit performs an allocation based on an input of preference information representing a preference for the user's viewing from the user.

(3)

The image processing apparatus according to (2), wherein the allocating unit performs an allocation based on the preference information and a position from which the user views.

(4)

The image processing apparatus according to (3), wherein the allocating unit performs an allocation based on an input of the preference information and the position from which the user views from the user.

(5)

The image processing apparatus according to (3), further including a viewing position detecting unit that detects the position from which the user views,

wherein the allocating unit performs an allocation based on the preference information and the position from which the user views detected by the viewing position detecting unit.

(6)

The image processing apparatus according to any one of (1) to (5), further including an image generating unit that generates the images of the two or more viewpoints in the display device from an image whose viewpoint number is smaller than the number of the two or more viewpoints, in the display device,

wherein the image of the predetermined viewpoint is at least one of the images of the two or more viewpoints in the display device generated by the image generating unit

(7)

The image processing apparatus according to (6), wherein the allocating unit uses an image whose viewpoint number is smaller than the number of the two or more viewpoints in the display device as the image of the predetermined viewpoint from the user based on an input for displaying a 3D graphics image as the image of the predetermined viewpoint.

(8)

The image processing apparatus according to (6) or (7), wherein the allocating unit uses an image whose viewpoint number is smaller than the number of the two or more viewpoints in the display device as the image of the predetermined viewpoint based on an error of the images of the two or more viewpoints in the display device generated by the image generating unit.

(9)

The image processing apparatus according to any one of (6) to (8), wherein the allocating unit uses at least one of the images of the two or more viewpoints in the display device generated by the image generating unit as the image of the predetermined viewpoint based on a disparity image corresponding to the images of the two or more viewpoints in the display device generated by the image generating unit.

(10)

The image processing apparatus according to any one of (1) to (5), further including an image generating unit that generates the image of the predetermined viewpoint from an image whose viewpoint number is smaller than the number of the predetermined viewpoint.

(11)

The image processing apparatus according to any one of (1) to (10), wherein the image of the predetermined viewpoint is a one-viewpoint image.

(12)

The image processing apparatus according to (1) to (10), wherein the image of the predetermined viewpoint is an image of two or more viewpoints, and

the allocating unit allocates the image of the predetermined viewpoint to every two consecutive viewpoints among the two or more viewpoints in the display device based on an input from the user.

(13)

The image processing apparatus according to (1) to (10), wherein the image of the predetermined viewpoint is an image of two or more viewpoints, and the allocating unit allocates a two-viewpoint image, having a small distance between left and right eyes of the user, included in the image of the predetermined viewpoint to two predetermined viewpoints corresponding to the distance between the left and right eyes of the user among the two or more viewpoints in the display device, and allocates a two-viewpoint image, having a long distance, included in the image of the predetermined viewpoint to two predetermined viewpoints other than the two predetermined viewpoints corresponding to the distance between the left and right eyes of the user, based on an input from the user.

(14)

The image processing apparatus according to (1) to (10), wherein the allocating unit allocates the image of the predetermined viewpoint and a predetermined image to the two or more viewpoints in the display device based on an input from the user.

(15)

A method of processing an image, including:

allocating, at an image processing apparatus, an image of a predetermined viewpoint to two or more viewpoints in a display device that displays images of the two or more viewpoints in a direction differing according to a viewpoint based on an input from a user; and

causing the image of the predetermined viewpoint to be displayed on the display device based on an allocation by the allocating process.

(16)

A program causing a computer to execute a process including:

allocating an image of a predetermined viewpoint to two or more viewpoints a display device that displays images of the two or more viewpoints in a direction differing according to a viewpoint based on an input from a user; and

causing the image of the predetermined viewpoint to be displayed on the display device based on an allocation by the allocating process.

The present disclosure contains subject matter related to that disclosed in Japanese Priority Patent Application JP 2011-086307 filed in the Japan Patent Office on Apr. 8, 2011, the entire content of which is hereby incorporated by reference.

What is claimed is:

1. An image processing apparatus comprising:
an allocating unit that allocates an image of a predetermined viewpoint to two or more viewpoints in a display device that displays images of the two or more viewpoints in a direction differing according to a viewpoint based on an input from a user; and
a display control unit that causes the image of the predetermined viewpoint to be displayed on the display device based on an allocation by the allocating unit.

2. The image processing apparatus according to claim 1, wherein the allocating unit performs an allocation based on an input of preference information representing a preference for the user's viewing from the user.

3. The image processing apparatus according to claim 2, wherein the allocating unit performs an allocation based on the preference information and a position from which the user views.

4. The image processing apparatus according to claim 3, wherein the allocating unit performs an allocation based on an input of the preference information and the position from which the user views from the user.

5. The image processing apparatus according to claim 3, further comprising a viewing position detecting unit that detects the position from which the user views,
wherein the allocating unit performs an allocation based on the preference information and the position from which the user views detected by the viewing position detecting unit.

6. The image processing apparatus according to claim 1, further comprising an image generating unit that generates the images of the two or more viewpoints in the display device from an image whose viewpoint number is smaller than the number of the two or more viewpoints, in the display device,
wherein the image of the predetermined viewpoint is at least one of the images of the two or more viewpoints in the display device generated by the image generating unit.

7. The image processing apparatus according to claim 6, wherein the allocating unit uses an image whose viewpoint number is smaller than the number of the two or more viewpoints in the display device as the image of the predetermined viewpoint from the user based on an input for displaying a 3D graphics image as the image of the predetermined viewpoint.

8. The image processing apparatus according to claim 6, wherein the allocating unit uses an image whose viewpoint number is smaller than the number of the two or more viewpoints in the display device as the image of the predetermined viewpoint based on an error of the images of the two or more viewpoints in the display device generated by the image generating unit.

9. The image processing apparatus according to claim 6, wherein the allocating unit uses at least one of the images of the two or more viewpoints in the display device generated by the image generating unit as the image of the predetermined viewpoint based on a disparity image corresponding to the images of the two or more viewpoints in the display device generated by the image generating unit.

10. The image processing apparatus according to claim 1, further comprising an image generating unit that generates the image of the predetermined viewpoint from an image whose viewpoint number is smaller than the number of the predetermined viewpoint.

11. The image processing apparatus according to claim 1, wherein the image of the predetermined viewpoint is a one-viewpoint image.

12. The image processing apparatus according to claim 1, wherein the image of the predetermined viewpoint is an image of two or more viewpoints, and
the allocating unit allocates the image of the predetermined viewpoint to every two consecutive viewpoints among the two or more viewpoints in the display device based on an input from the user.

13. The image processing apparatus according to claim 1, wherein the image of the predetermined viewpoint is an image of two or more viewpoints, and
the allocating unit allocates a two-viewpoint image, having a small distance between left and right eyes of the user, included in the image of the predetermined viewpoint to two predetermined viewpoints corresponding to the distance between the left and right eyes of the user among the two or more viewpoints in the display device, and allocates a two-viewpoint image, having a long distance, included in the image of the predetermined viewpoint to two predetermined viewpoints other than the two predetermined viewpoints corresponding to the distance between the left and right eyes of the user, based on an input from the user.

14. The image processing apparatus according to claim 1, wherein the allocating unit allocates the image of the predetermined viewpoint and a predetermined image to the two or more viewpoints in the display device based on an input from the user.

15. A method of processing an image comprising:
allocating, at an image processing apparatus, an image of a predetermined viewpoint to two or more viewpoints in a display device that displays images of the two or more viewpoints in a direction differing according to a viewpoint based on an input from a user; and
causing the image of the predetermined viewpoint to be displayed on the display device based on an allocation by the allocating process.

16. A program causing a computer to execute a process comprising:
allocating an image of a predetermined viewpoint to two or more viewpoints in a display device that displays images of the two or more viewpoints in a direction differing according to a viewpoint based on an input from a user; and
causing the image of the predetermined viewpoint to be displayed on the display device based on an allocation by the allocating process.
